(19) United States
(12) Patent Application Publication
(10) Pub. No.: US 2024/0215759 A1
(43) Pub. Date: Jul. 4, 2024

(54) GRILL DEVICE

(71) Applicant: Ori LAVI, Herzliya (IL)

(72) Inventor: Ori LAVI, Herzliya (IL)

(21) Appl. No.: 18/401,650

(22) Filed: Jan. 1, 2024

(30) Foreign Application Priority Data
Jan. 1, 2023 (IL) 299629

(51) Int. Cl. A47J 37/07; A47J 36/26; F24C 3/08; F24C 15/14

(52) U.S. Cl. CPC A47J 37/0713; A47J 36/26; A47J 37/0786; F24C 3/085; F24C 15/14; F24C 15/086

(57) ABSTRACT

A multi-floor grill device with a plurality of working surface types arranged adjacent each other and interfacing each other to create stations for processing foodstuff in a grill device in a convenient way. Drip ducts or trays are relocated to a bottom floor beneath a top floor that accommodates the working surfaces. A plurality of gas burners are placed under a cooking grid and may be covered with heat plates with fins that interrupt solid residues falling off of cooked foodstuff on the grid from resting and accumulating on the plates. Working surfaces for processing the foodstuff before cooking are placed at the front of the top floor and made conveniently accessible to a user. These surfaces receive induced heat from the cooking grid that pre-warms the foodstuff before cooking and shortens its cooking time.

### TECHNICAL FIELD

The present invention pertains to a grill device. In particular, the present invention pertains to a multi-floor, multi-working-surface design of a grill device that integrates several working surfaces and fluid collecting trays into a single platform. This integration makes these working surfaces more conveniently accessible to the user and renders the processing of food advantageous and more efficient than its processing in current designs of grill devices.

### BACKGROUND

Current grill devices are designed with a main surface of a cooking grid, a main body that accommodates a set of gas burners under the cooking grid, a control panel with gas control knobs, which are connected to the gas burners and a hood above the cooking grid. Some grill devices also contain grease trays at the sides of the cooking grid to let excess of meat fat and juice drip down and be collected in a bottom tray and an after-cooking rack at the back of the cooking grid that keeps the cooked food warm and frees up working area of the cooking grid. In other designs, drainage of excess juices takes place into a drip duct at the front side of the cooking grid above the control panel and beside the cooking grid. Preparation of the foodstuff before cooking is usually done on a separate auxiliary table beside the grill device. Such designs are limited because the cooking grid that takes most of the working area and the front drainage duct do not leave space for a working surface close to the front panel for preparing foodstuff before cooking. The cooking grid also limits comfortable access to the back after-cooking rack and makes the side or auxiliary grease trays only partly useful. Another faulty design is slope shaped heat plates that cover the open flame gas burners under the cooking grid. These plates accumulate solid residues on their top and/or sides that fall off of the food items, which are cooked on the cooking grid. As a result, these residues are not collected at a bottom tray and are left on the heat plates for cleaning. Another disadvantage of current designs of grill devices is the straight shape of the front side of the storage cabinet and/or lower body of the grill device that carries the cooking grid on top. Such a straight front side limits a user from conveniently approaching the working surfaces when standing in front of the device.

It is, therefore, an object of the present invention to provide a grill device with a design and elements that overcome the problems and disadvantages of current grill devices.

It is yet another object of the present invention to provide a grill device with a design that further imparts additional elements and capabilities for improved operation.

This and other objects and embodiments of the present invention will become apparent as the description proceeds.

### SUMMARY

In one aspect, the invention is a grill device that integrates all the working surfaces in the sequence of processing foodstuff on a grill. In particular, the grill device comprises these working surfaces adjacent one to the other and conveniently accessible to a user, so that processed foodstuff can be easily transported between processing stations. In still another embodiment, the arrangement of the working surfaces in the grill device provides additional improvement to the cooking process by exploiting their relative location to use induced heat from the cooking grid to pre-warm the foodstuff, e.g. meat, before cooking and shorten the cooking time on the grid. This arrangement of working surfaces in the grill device is made possible by relocating the drip duct or side trays to a lower floor under an upper floor that accommodates the working surfaces. The advantage of this configuration is at least two-fold. It releases a significant working space, which is easily accessible to the user. It practically eliminates the distances between the working surfaces, which allows passing the foodstuff from one processing station to another without carrying it. At the same time it uses the induced heat from the cooking grid to pre-warm the foodstuff on the front working surface before cooking. Further, the front pre-warming surface can be grated to allow excess fluids to drip down to a drip duct or tray directly under it at the lower floor.

In one embodiment, the front pre-warming surface may be used as a working surface for preparing the foodstuff before cooking, e.g. cutting, cleaning, defrosting. Accordingly, in a further particular design, the pre-warming surface is configured to carry a working board to process the foodstuff before cooking. Such a working board can be firmly held in place on the pre-warming surface with securing means. Such securing means may be a solid frame around the borders of the pre-warming surface that matches the dimensions of the working board or two or more pillars, each at a corner of the pre-warming surface, that match the edges of the working board and mechanically lock it in place. Such frame and pillars are designed to frictionally engage with the working board and secure it in place, particularly when processing foodstuff on it. The working board can be released by simply removing it off of the pre-warming surface.

In another embodiment, the grill device of the present invention further improves convenience and accessibility of the working surfaces to a user with an inwardly sloped shape of the lower edge of the cabinet or body that carry the working surfaces. Such sloped shape of the cabinet/body enables the user to reach closer to the working surfaces and better control the cooking process in all the stations.

The following description details aspects and embodiments of the grill device of the present invention without departing from its scope as described above and with reference to the accompanying drawings.

### BRIEF DESCRIPTION OF THE DRAWINGS

FIG. 1 illustrates a perspective view of the grill of the present invention.

FIG. 2 illustrates a front view of the grill with another particular configuration of its front panel.

FIG. 3 illustrates a front view of the grill with another particular configuration of its front panel.

FIG. 4 illustrates a rear view of the grill

FIG. 5 illustrates a top view of the grill's working area with additional working surfaces.

FIG. 6 shows the perspective top view of the grill with additional working surfaces.

FIG. 7 shows inner working parts of the grill including a particular design of gas burners.

FIG. 8 shows a close-up view of the inner parts of the grill.

FIG. 9 shows a lower liquid accumulation tray of the grill under its working areas.

FIG. 10 shows inner parts of the grill including gas operation and residues accumulating lower tray.

FIG. 11 shows a top view of the grill with an array of elongated burners located under the grill plates.

FIG. 12 shows a perspective view of the entire grill without the grill plate, exposing an array of burner under it.

FIGS. 13-16 show the grill with detachable covers on its walls.

FIG. 17 shows the collecting tray under the working surfaces of the grill.

FIG. 18 shows the lower part of the grill with an array of gas operation parts and gas safety valve.

FIG. 19 shows inner parts of the grill additional working surfaces on its pre-warming surfaces.

FIG. 20 shows the array of burners in an operational mode.

FIGS. 21a-h show an array of burners gradually ignited to operational mode.

FIGS. 22-26 illustrate another embodiment of the grill of the present invention.

FIG. 27 illustrates additional features of the collecting trays floating under the working surfaces and between the trays and the grill surface.

FIG. 28 illustrates a partially exploded view of the front of the grill with the features shown in FIG. 27.

FIG. 29 illustrates another partially exploded view of the front of the grill with the features shown in FIG. 27.

FIG. 30 illustrates a bridge laid over the sides of the floating collecting trays under the working surface one side and the cooking grid on the other side.

FIG. 31 illustrates a close up view of the bridge shown in FIG. 30.

### DETAILED DESCRIPTION OF THE DRAWINGS

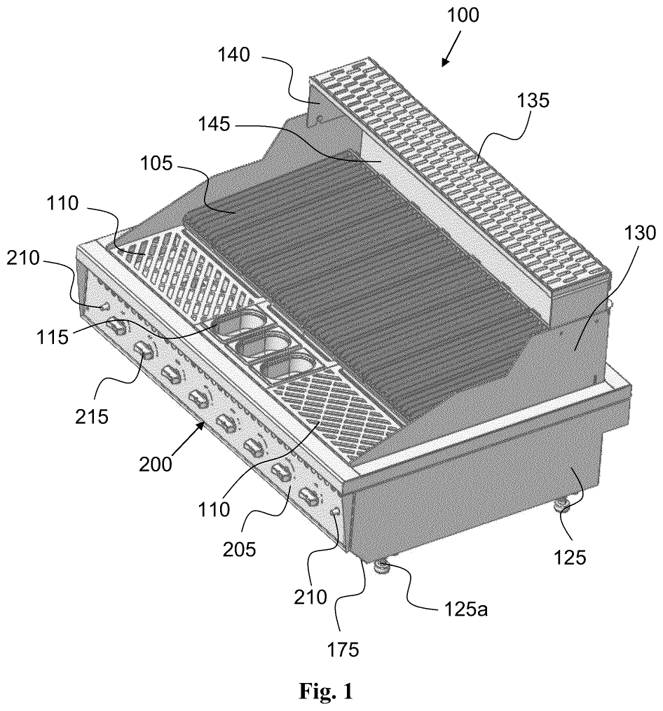

FIG. 1 is a perspective view illustration of the grill device 100 of the present invention. Its main parts are the cooking grid 105, pre-warming and working surfaces 110, control panel 200 and after-cooking grid 135. Other parts of the grill device 100 include lower cabinet or body 125, seasoning bowls 115 and wing shields 130. The lower cabinet/body 125 may be adjusted to the floor on which it stands with leveling legs 125a.

This arrangement integrates these working surfaces, 105, 110 and 135 in one area and makes them conveniently accessible to a user who stands in front of the control panel 200 and operates the grill device 100. Particularly, the pre-warming surfaces 110 are located near the front edge of the grill device to allow the user to treat and process the foodstuff before placing it on the cooking grid 105. The seasoning bowls 115 are also located within hands reach between working/pre-warming surfaces 110 to treat the foodstuff before and during cooking.

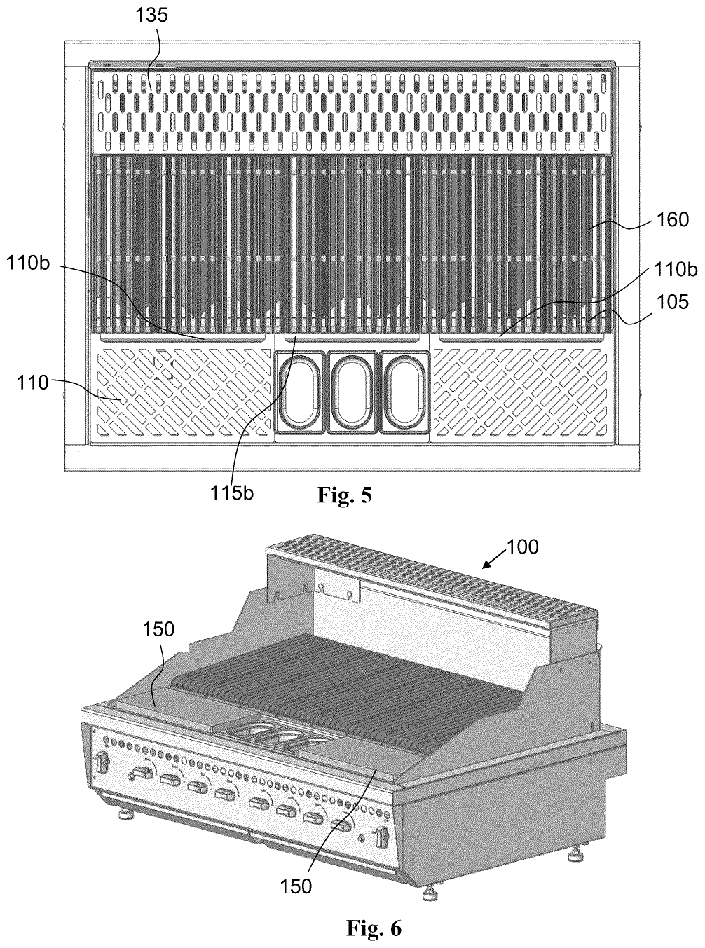

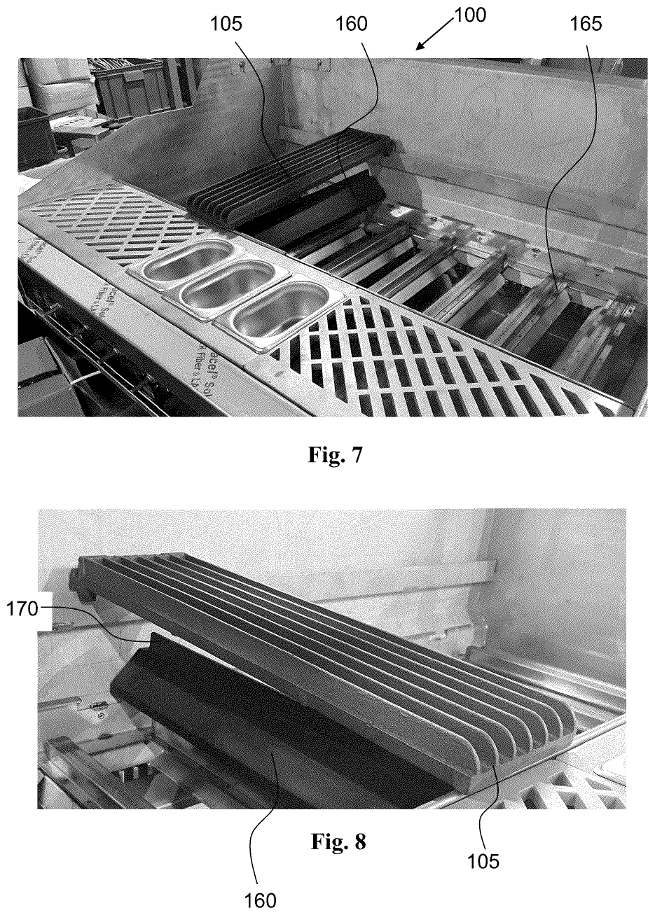

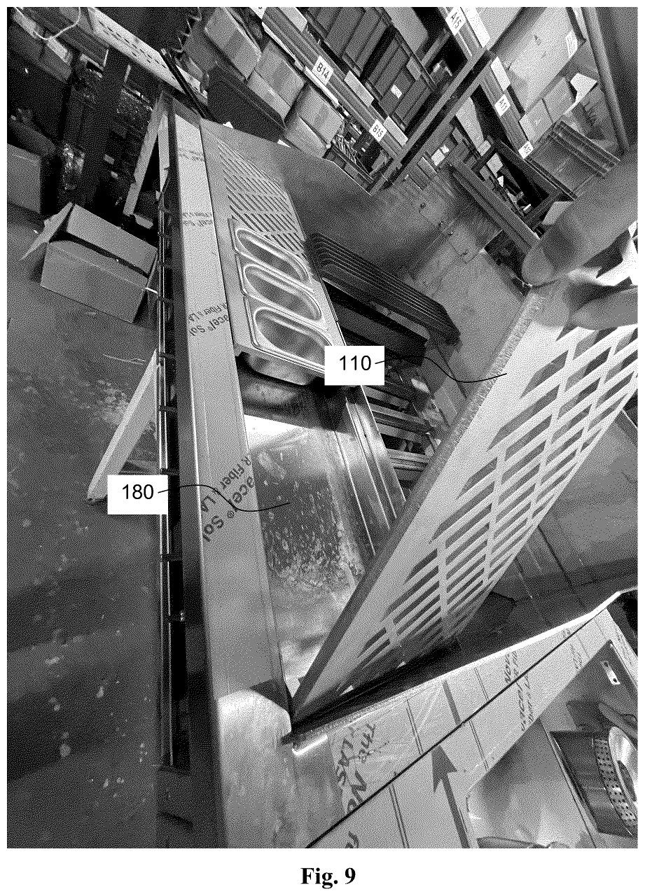

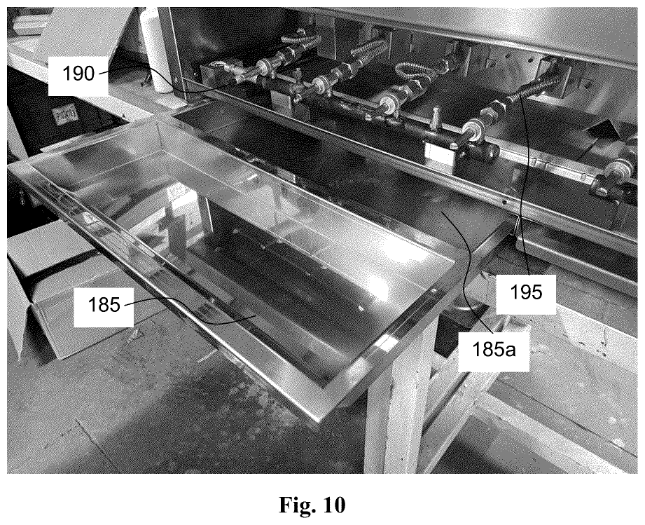

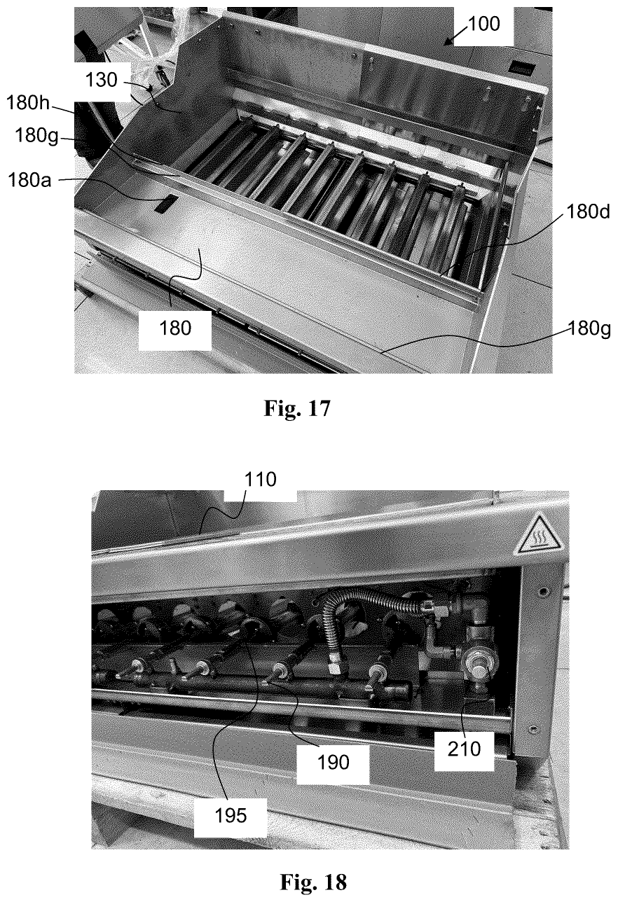

The working surfaces 105 and 110 are in the upper floor of the grill device and are grated to allow fluids and residues to drip down to collecting trays in the lower floor of the device. The pictures in FIGS. 9 and 10 show the collecting trays 180 and 185 under the working surface 110 and cooking grid 105, respectively. The collecting tray 180 under the working s surfaces can be slightly sloped to concentrate the dripped fluids on one side or a selected volume of the trays. FIG. 17 shows the collecting tray 180 under the working surfaces 110 with a drainage hole 180a that lets the fluids from processed food on the working surfaces 110 flow down to the collecting tray 185 instead of accumulating on tray 180. The tray under the cooking grid 105 is actually a double tray. Tray 185 is placed inside tray 185a and accommodates only part of it, specifically its proximal part under tray 180. Tray 185, therefore receives the fluids that drain out of the processed food on the working surface 110. The other distal part of 185a is located under the cooking grid 105 and collects the solid parts and residues that fall off of the foodstuff that is cooked on the grid through its grate. This way the fluid and solid residues are collected separately from each other, letting better handling of the waste. Tray 185a can be pulled out from under the cooking grid and working surfaces. Then tray 185 can be taken out and drained off of the fluid waste and the distal part of tray 185a can be cleaned from the solid residues. When falling through the grate, the solid residues rest and accumulate on the heat plates 160 that cover the open fire gas burners 165 as shown in FIG. 7. To prevent this, the heat plates 165 comprise a fin 170 at their top part and along their length that prevents solid parts from resting on top of the plates and accumulating there, see FIG. 8. Fin 170 interrupts the falling and accumulation of such solid residues on top of the heat plates 160 through the grate and forces them down the slope of the plates and into the collecting tray 185 beneath. FIG. 5 shows a top view illustration of the top working area of the grill device with the heat plates 160 made more visible through the grate of the cooking grid 105.

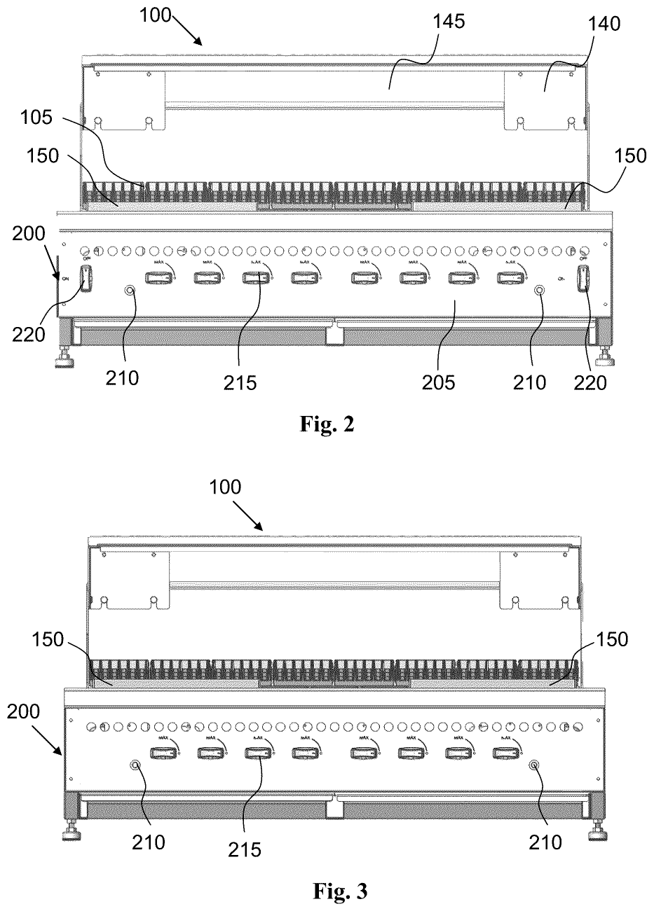

The control panel 200 comprises a front wall 205, from which gas knobs 215 protrude. The control panel may have several configurations as illustrated in FIGS. 1-3. FIG. 1 shows the control panel 200 with a number of burner knobs 215. The number of knobs is equal to the number of burners 165 of the grill device 100. Safety valve(s) 210 keep gas pressure constant to prevent overpressure in the gas pipes. Ignition knob(s) 220 ignite the gas at the gas burners after opening gas flow to the burners with gas control knobs 215. The ignition knob 220 and gas knob 215 provide a double control on turning the gas flame on. FIG. 16 shows safety valve 210 that keeps the gas pressure in the gas pipes normal and drains out excess gas.

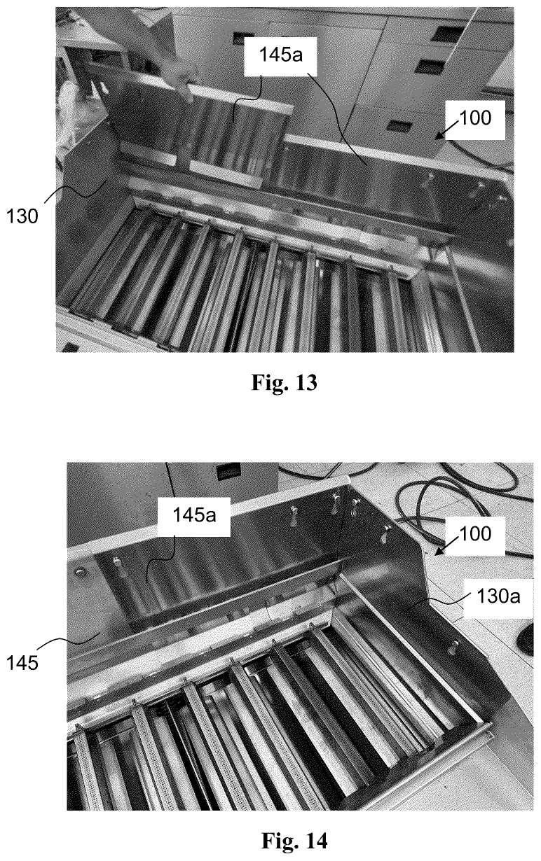

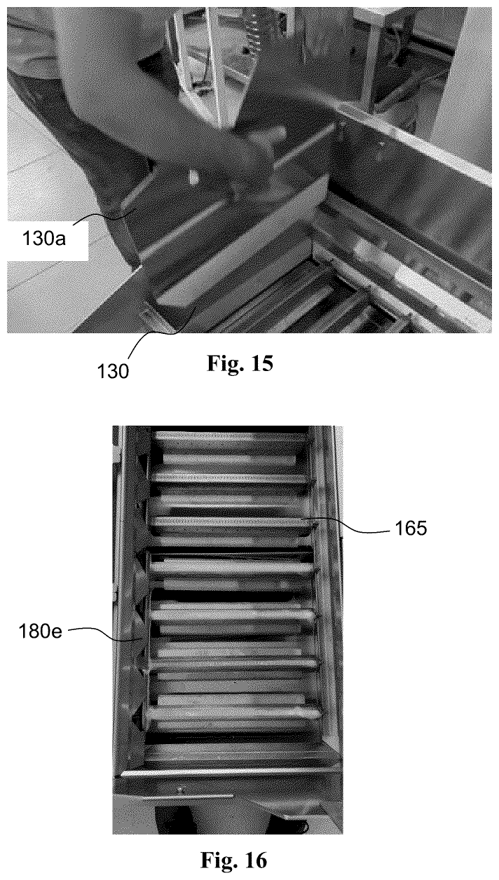

The four variations of the control panel 200 of the grill device in FIGS. 1-3 are only representatives of the arrangements and use of the different gas control knobs and valves that may be used. Different combinations of the arrangements of knobs 215 and valves in FIGS. 1-3 are contemplated within the scope of the present invention. FIGS. 13-16 show that the support back 145 and side shields 130, respectively, and the walls around the burners 165 of the grill is covered with detachable covers 145a and 130a. These covers protect the metallic body of the grill from overheating, strain-stress and cooling-relaxation cycles due to high heat, burning, and twisting and weakening of overtime and use. Since these covers are detachable, they are also replaceable with new covers after exhausting their service life. As a result, the grill enjoys a considerably longer service life and is maintained in a highly operative mode for a longer period of time. In addition, these covers protect the grill walls and sensitive parts from accumulated grease, food residues and dirt. Because they are detachable, they can be easily taken out for washing and cleaning from food residues and grease, which are accumulated in the preparation of food on the grill. This makes cleaning and maintenance of the grill easier, without requiring cleaning and washing the entire body of the grill. A further advantage is in separating its structural parts from operational ones such as the gas burners and preventing water and detergents from filtrating into the gas burners and creating corrosion and wear over time.

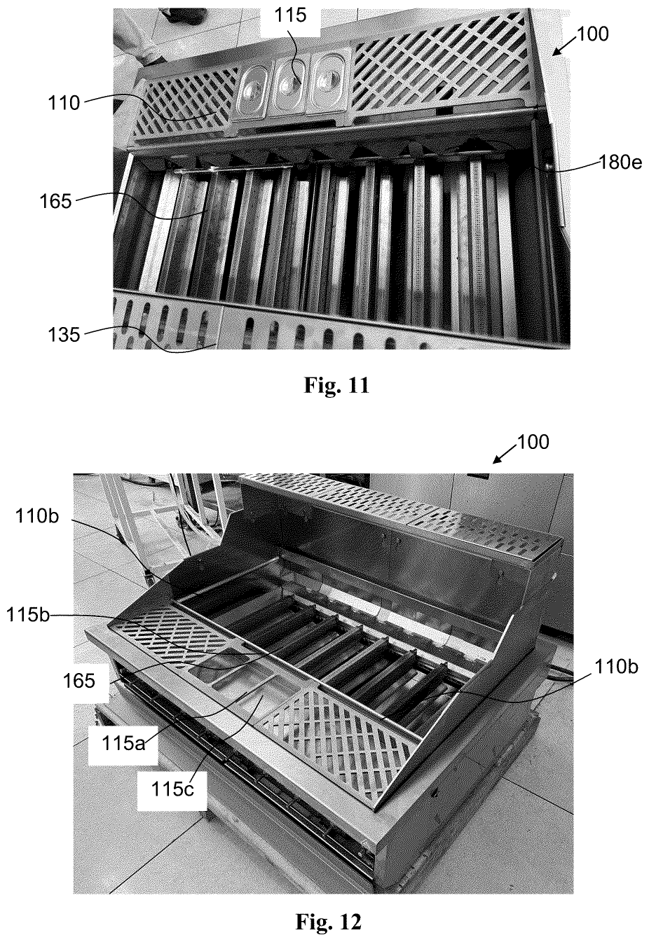

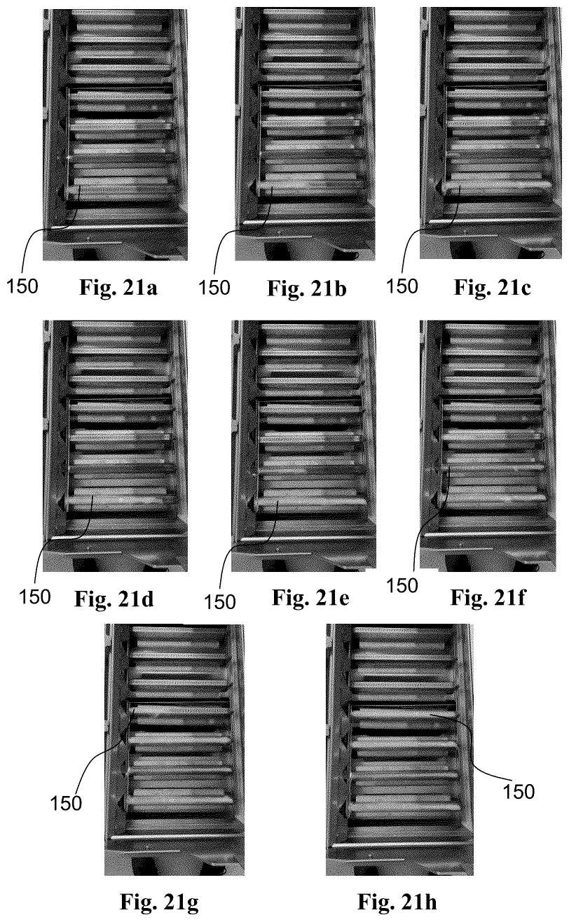

FIG. 10 shows gas pipes 195 connecting between the operational part 190 of the gas knobs 215 and gas burners 165, see FIG. 7 for example. Rectangular, elongated burners 165 with a plurality of outlet holes may be used in the grill device 100 of the present invention as shown in FIG. 11. As shown, burner 165 has a rectangular shape with a plurality of gas outlets along its length. FIG. 18 shows the array of gas pipes 195, the operational part of the gas knobs 190 and gas at the lower floor of the grill part of the grill with an array of gas operation parts and gas safety valve 210. A plurality of rectangular gas burners 165 are arranged parallel each other along the length of the cabinet or body of the grill device. The shape of the rectangular burner 165, gas pressure and streaming speed in the pipe from the gas tank to the burner and along the length of the burner generates a stable and steady, high temperature flame along its entire length. FIG. 18 shows the array of gas burners 165 in an operational mode. The rectangular burners 165 are designed with a plurality of outlets and inner shape to control the rate and intensity of gas flow and produce gas flames at optimal temperature and consistency. As shown in FIG. 20, the flame is stable, steady and clean at a high temperature without gas bursts along the entire length of the burners 165 and extending above from the plurality of outlets of the burners. FIGS. 21a-h exemplify the mode of ignition of an array of burners in a series of photos. As shown, the burners are ignited in a serial mode, where the ignition of every burner starts at the gas inlet point and advances as the gas proceeds to flow along the burner at a stable, steady high temperature flame along entire length of said gas burners.

The partial hood of the grill device 100 also comprises a top after-cooking grid 135, which can be used as an after-cooking surface for placing cooked foodstuff, e.g. meat steaks. This top after-cooking grid 135 has a support back 145 that also closes the back side of the cooking grid 105, and side supports 140 that connect to side shields 130 of the grill device. The combination of the top after-cooking grid 135, support back 145, side supports 140 and side shields 130 creates a partial hood above the cooking surface 105 of the grill device.

To make the working surfaces 110, 105 more conveniently accessible to a user, the bottom edge 175 of the cabinet/body 125 is sloped inwards, to allow the user stand closer to the working surfaces and more easily reach the processed foodstuff in the different stations.

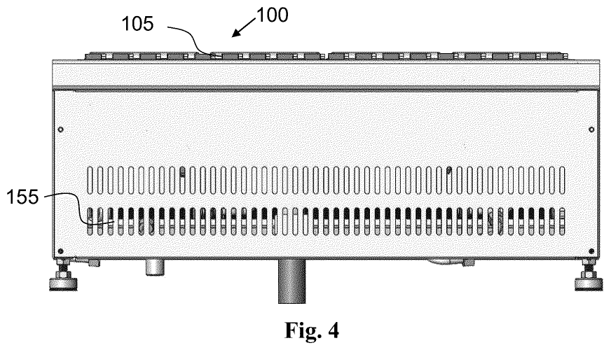

FIG. 4 illustrates the back side of the body/cabinet 125, with air outlets 155 to release heat out of the inner space of the cabinet/body to the surrounding, ventilate the air inside and cool it.

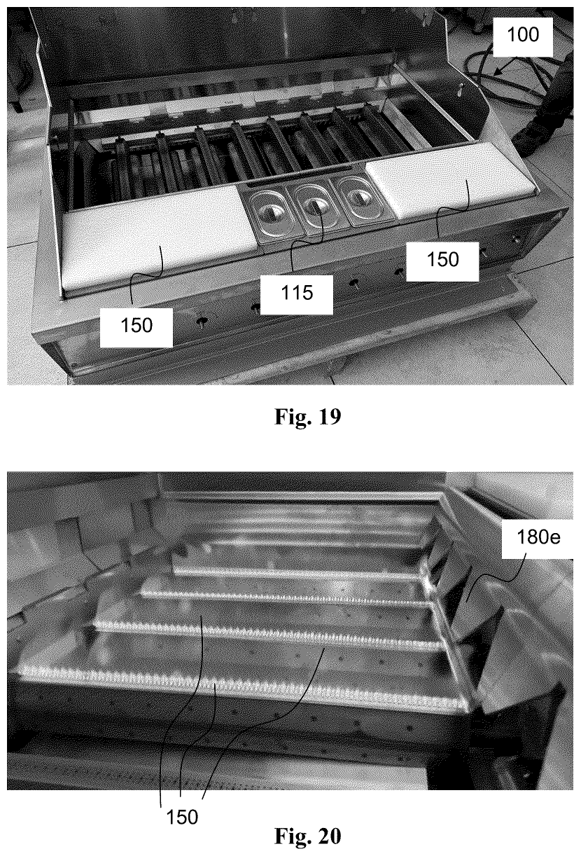

FIG. 6 illustrates working boards 150 placed on the working surfaces 110 to process the foodstuff before cooking. FIG. 19 shows actual working boards 150 placed on top of the working surfaces 110. Such a working board can be placed and sit firmly on the working surface without securing means due to its weight. In another option, the working boards are firmly held in place on the pre-warming/working surface with securing means. Such securing means may be poles extending up from corners of the working surface diagonally positioned relative each other and introduced into the working boards. Alternatively, the securing means may be a solid frame around the borders of the pre-warming surface that matches the dimensions of the working boards or two or more poles diagonally positioned relative each other at the corners of the working surface that match the edges of the working board and mechanically lock it in place. Such frame and poles are designed to frictionally engage with the working boards and secure them in place, particularly when processing foodstuff on them. The working board 150 can be released by simply removing it off of the pre-warming/working surface 110.

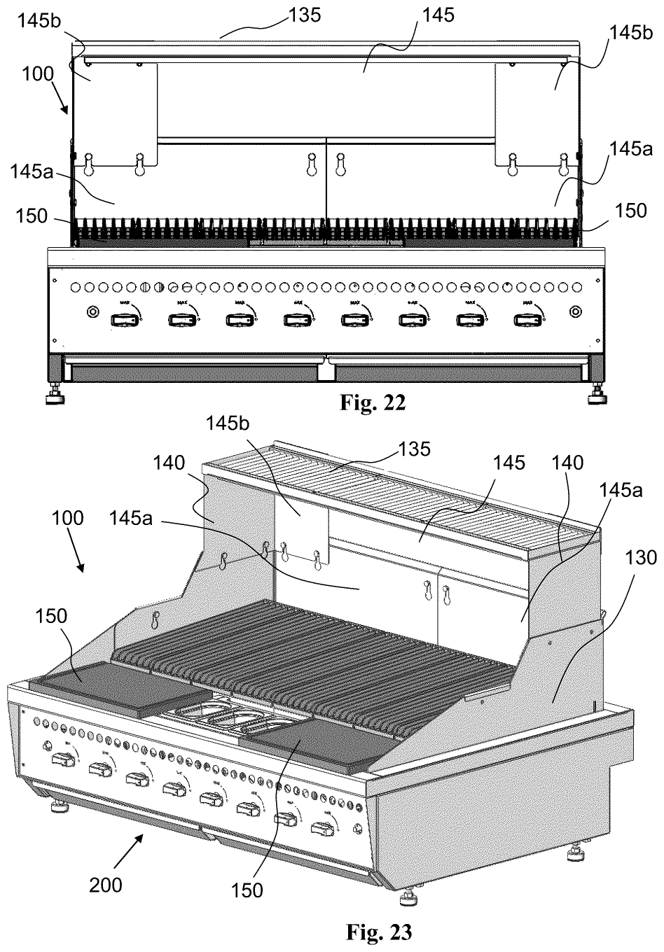

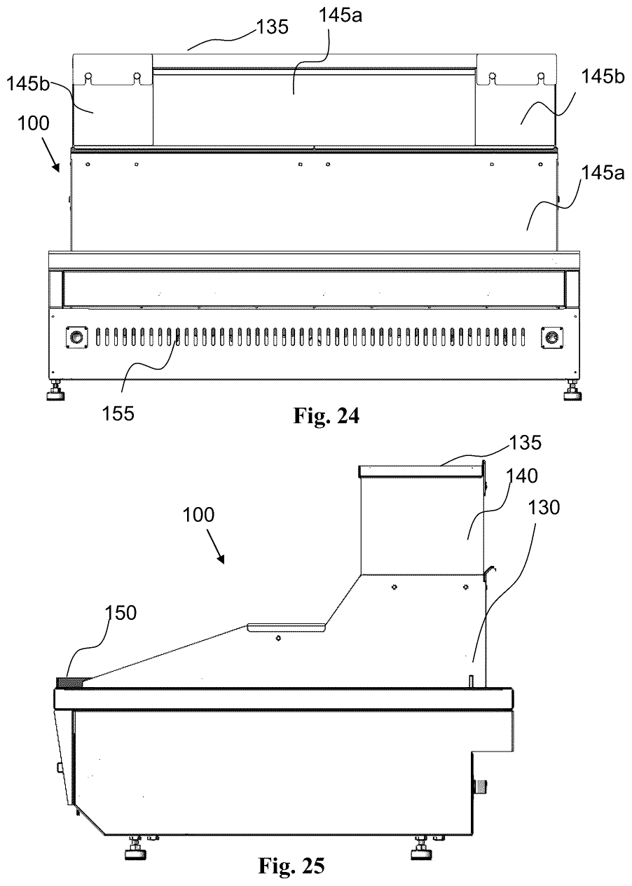

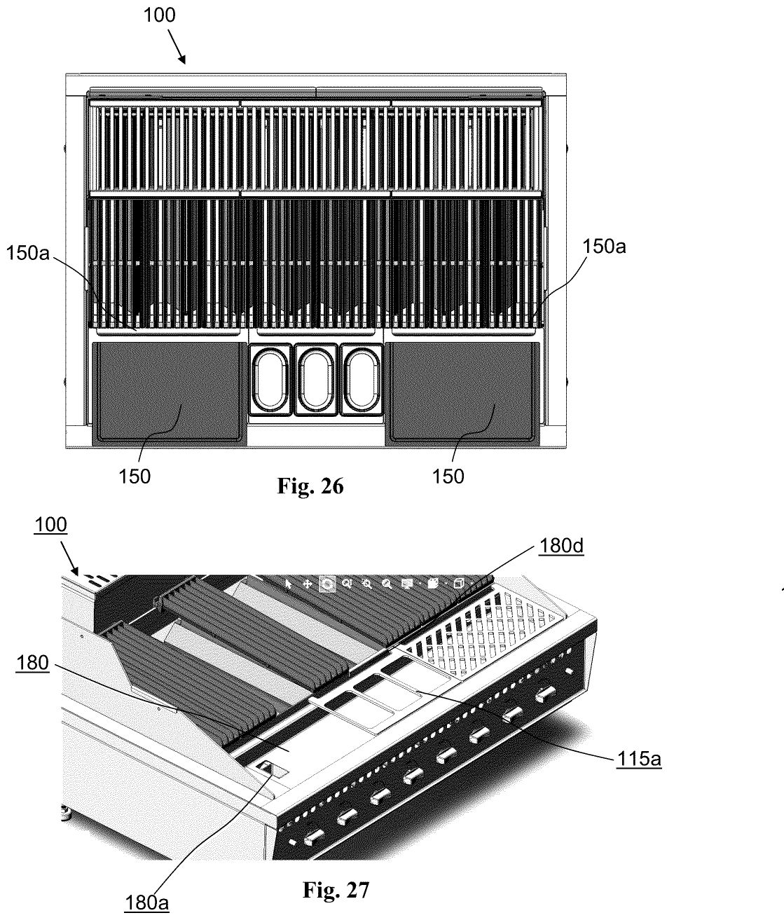

FIGS. 22-26 illustrate another embodiment of the grill of the present invention, in which the top after-cooking grid 135 is further elevated above the cooking grid 105. This is done by extending the support back 145 further up with horizontal 145b and vertical 145c plates and extended side walls 140 all attached to side shields 130. Another modification is further distancing the working boards 150 from the cooking grid 105. The gap 150a between the working boards 150 and the cooking grid 105 thermally insulates the working boards 150 from the cooking grid 105. As a result, foodstuff processed on the working boards 150 can be warmed by the heat that the cooking grid 105 induces on its surroundings without cooking it. In addition, the working boards 150 are made closer to the edge of the grill 100, thus facilitating an easier and more convenient access for a user standing beside the grill 100 and processing foodstuff on the working boards 150 before cooking.

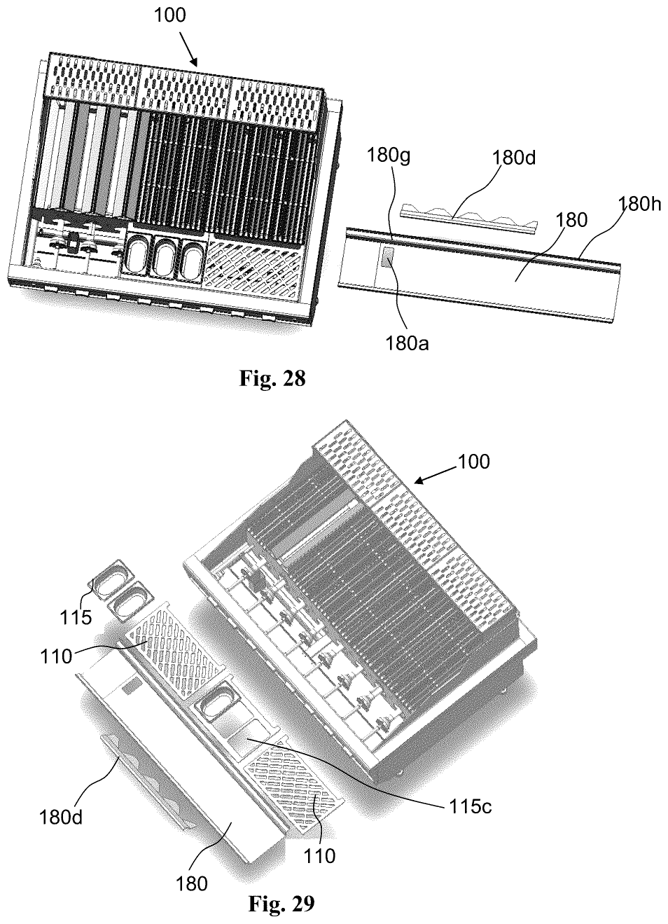

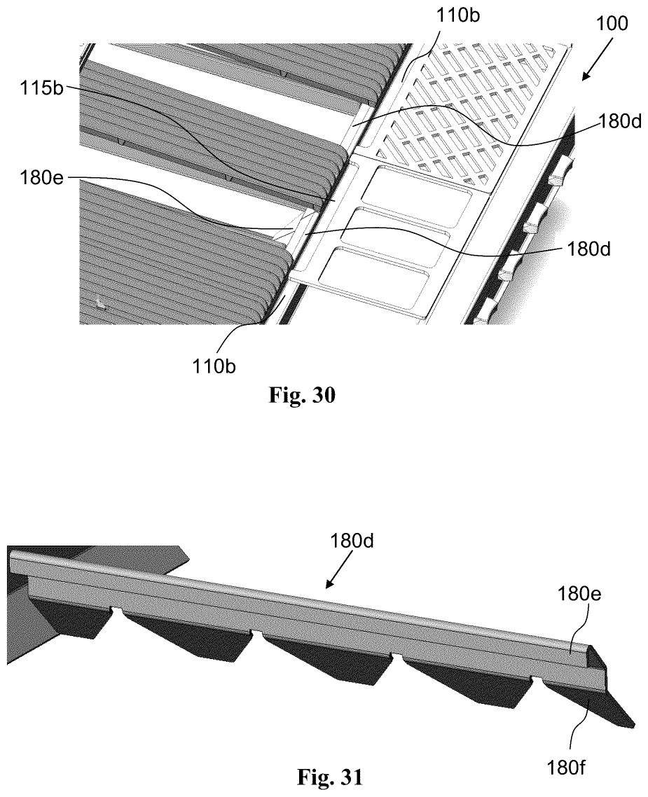

FIG. 27 shows the collecting tray 180 floating under the working surfaces 110 and seasoning bowls 115 and above collecting tray 185. As shown in FIGS. 17, 28, Benches 180g on the sides of the collecting tray 180 hold the working surfaces 110 and the frame 115a (see FIGS. 12, 27) that accommodates and holds the seasoning bowls 115 in their respective openings 115c (see FIGS. 12, 29) above the collecting tray 180. A bridge 180d (see FIGS. 17, 29, 31) is placed over the edge 180h (see FIGS. 17, 28) bordering the cooking grid 105 on one side and bench 180g of the collecting tray 180 on the other side facing the collecting tray 180. The bridge 180d provides a smooth, continuous path for juices coming out of the grilled food on the cooking grid 105 to flow down to the collecting trays, 185a, 180, under the cooking grid 105 and the working surfaces and seasoning bowls, respectively. Openings 110b, 115b (see FIGS. 5, 30) in the working surfaces 110 and the frame 115a that holds the bowls, respectively, make a gap between the working surfaces and frame and the edge of the cooking grid 105 to allow the food juices to flow over the bridge 180d down to the collecting tray 180 underneath. The bridge 180d has a front side 180f that faces the front edge of the working surfaces 110 and seasoning bowls 115 that leads to collecting tray 180 and a rear side 180e (see FIGS. 16, 20, 31) that faces the cooking grid 105 and leads to the collecting tray 185a underneath and between the heat plates 160 that cover the gas burners 165. The bridge 180d allows fluids to drain right down into the collecting trays without coming in contact with the open fire of the gas burners 165 under the cooking grid 105, staining and damaging the burners and vaporizing into fumes above the grill and obstructing the sight of the grilled food. The fluids collected in the collecting tray 180 also induce heat to pre-processed food on the working surfaces 110. Further down they are drained to the collecting tray 185, which is located under the collecting tray 180 through outlet 180a.

1. A multi-floor grill device comprising:
a top floor comprising an integrated working area with at least two types of working surfaces;
a bottom floor comprising fluid and residue collecting trays beneath said working surfaces;
a cabinet or body comprising inner volume that accommodates a plurality of gas burners and carrying said top floor;
a front control panel comprising a plurality of gas knobs for controlling gas flames which are set off in said gas burners; and
a partial hood comprising a top after-cooking grid,
wherein said two types of surfaces in said working area in said top floor comprise a cooking grid and working surfaces for processing foodstuff before placing on said cooking grid, wherein said working surfaces are adjacent and interface said cooking grid and in front of said cooking grid, said cooking grid and working surfaces create adjacent stations for processing said foodstuff,
wherein said cooking grid and fluids in said collecting trays induce heat on said working surfaces, wherein said heat of said working surfaces pre-warms said foodstuff before placing it on said cooking grid.

2. The multi-floor grill device according to claim 1, wherein said working surface are grated, wherein excess fluids and residues fall off of grate of said working surfaces to a collecting tray at said bottom floor and under said working surfaces.

3. The multi-floor grill device according claim 2, wherein said collecting tray comprises a drainage hole for draining fluids and food residues down to a second collecting tray.

4. The multi-floor grill device according to claim 3, wherein said second collecting tray is placed in a third collecting tray and occupying part of said third collecting tray, said second collecting tray is configured to be pulled out of said third tray for draining fluid residues of processed food on said working surface, said third tray is located under said cooking grid and configured to collect solid residues falling off of said foodstuff cooked on said cooking grid.

5. The multi-floor grill device according to claim 4, wherein said third tray is configured to be pulled out beneath said cooking grid and working surfaces.

6. The multi-floor grill device according to claim 1, wherein said working surfaces are configured to place a working board on them for processing said foodstuff before cooking.

7. The multi-floor grill device according to claim 6, wherein said working surface further comprises securing means for securing said working board on them.

8. The multi-floor grill device according to claim 7, wherein said securing means comprise poles extending from diagonally positioned corners of said working surfaces and configured to be introduced into said working board.

9. The multi-floor grill device according to claim 7, wherein said securing means frictionally engaging with said working board and holding it in place.

10. The multi-floor grill device according to claim 7, wherein said securing means is a solid frame around borders of said working surface that matches dimensions of said working board.

11. The multi-floor grill device according to claim 7, wherein said securing means are two or more poles, diagonally positioned at corners of said working surface relative each other, said poles matching edges of said working board and frictionally lock it in place.

12. The multi-floor grill device according to claim 6, wherein said working board is placed over said working surfaces close to edge of said grill device, wherein location of said working board on said working surfaces creates an air gap between said working board and cooking grid, said air gap is configured to warm said foodstuff processed on said working board with heat induced by said cooking grid without cooking said foodstuff.

13. The multi-floor grill device according to claim 1, wherein said gas burners are elongated rectangular gas burners with a plurality of gas outlets, said gas burners are arranged parallel each other along length of said cabinet/board, wherein gas pressure and streaming speed in gas pipes connecting between a gas tank and said gas burners and along length of said burners generate a stable, steady high temperature flame along entire length of said gas burners.

14. The multi-floor grill device according to claim 13, further comprising heat plates that cover an open fire gas of said elongated rectangular gas burners, wherein said heat plates comprise fins at their top part and along their length, said fins interrupt solid parts falling off of said foodstuff cooked on said cooking grid through grate of said grid and prevent them from resting, accumulating on top of said heat plates and force them down slope of said heat plates and into a collecting tray under said gas burners.

15. The multi-floor grill device according to claim 1, wherein said control panel further comprises safety valve(s) that keep a gas pressure constant to prevent overpressure in gas pipes, and ignition knob(s) from igniting gas in said gas burners after opening gas flow to said gas burners with said gas knobs, said ignition knob(s) and gas knob(s) providing a double control on turning said gas flame on.

16. The multi-floor grill device according to claim 1, wherein said partial hood comprises side shields connected to side of said cabinet/body of said grill device, side supports connected to said side shields on one end and said top after-cooking grid on opposite end and a support back connecting said top after-cooking grid to back side of said cabinet/body of said grill device.

17. The multi-floor grill device according to claim 16, wherein said support back, side shields and walls of cabinet of said grill around said burners are covered with detachable covers, said covers are configured to shield metallic body of said grill device from overheating, strain-stress and cooling-relaxation cycles due to high heat, burning, twisting and weakening overtime and use, protecting walls and sensitive parts of said grill device from accumulated grease, food residues and dirt, and corrosion enhancing materials comprising water and detergents.

18. The multi-floor grill device according to claim 16, wherein said covers are detachable and replaceable.

19. The multi-floor grill device according to claim 16, wherein said support back is extended further up with horizontal and vertical plates and extended side walls, wherein extension of said support back elevates said after-cooking grid above said cooking grid.

20. The multi-floor grill device according to claim 1, wherein said top after-cooking grid is an after-cooking surface for placing said foodstuff cooked on said cooking grid.

21. The multi-floor grill device according to claim 1, wherein said collecting trays comprise a collecting tray under said gas burners in said cabinet/body of said grill device.

22. The multi-floor grill device according to claim 1, further comprising air outlets at back side of said grill device for releasing heat out of inner space of said cabinet/body to surroundings of said grill device and ventilate and cool air inside said body/cabinet.

23. The multi-floor grill device according to claim 1, wherein bottom edge of said cabinet/body is sloped to allow a user to more closely stand beside said grill device and process said foodstuff on said working surfaces.

24. The multi-floor grill device according to claim 1, further comprising seasoning bowls at front of said top floor and between working surfaces for processing said foodstuff before placing said foodstuff on said cooking grid.

25. The multi-floor grill device according to claim 1, wherein a collecting tray under said working surfaces comprises benches on its sides,
wherein said multi-floor grill device further comprises a frame, said frame comprising openings suitable for accommodating and holding seasoning bowls in said openings of said frame, wherein said benches hold said working surfaces and said frame above said collecting tray underneath,
wherein said working surfaces and said frame comprise an opening between said frame and an edge bordering said bench on one side and said cooking grid on the other side.

26. The multi-floor grill device according to claim 25, further comprising a bridge placed over said edge, said bridge comprising front and rear sides that enable flow of juices of said foodstuff cooked on said cooking grid down to said collecting tray floating beneath said working surfaces and seasoning bowls through said openings and to a collecting tray under said cooking grid.

27. The multi-floor grill device according to claim 1, wherein said cabinet/body comprises leveling legs for adjusting said grill device to a floor on which it stands.
